(19) United States
(12) Patent Application Publication
(10) Pub. No.: US 2011/0039235 A1
(43) Pub. Date: Feb. 17, 2011

(54) METHOD FOR SIMULATING FLIGHT ATTITUDES OF AN AIRCRAFT CAPABLE OF VERTICAL TAKEOFF AND/OR VERTICAL LANDING

(75) Inventor: Andreas Margreiter, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Wunderwerk Digitale Medien Production GmbH, 1060 Wien (AT)

(21) Appl. No.: 12/863,518

(22) PCT Filed: Jan. 16, 2009
(86) PCT No.: PCT/AT2009/000012

§ 371 Date: Sep. 21, 2010

(30) Foreign Application Priority Data
Jan. 18, 2008 (AT) A 76/2008

(51) Int. Cl. G09B 19/16

(52) U.S. Cl. 434/35

(57) ABSTRACT

In a method for simulating flight attitudes of an aircraft capable of vertical take-off and/or vertical landing, with a simulator having a movement device configured as an industrial robot having serial kinematics, wherein movements of a first support for at least one subject positioned on the movement device are controlled by at least one control element, it is proposed for a realistic simulation of critical flight attitudes that the at least one control element is actuated by a subject positioned in the first support such that a ground contact device connected to the first support, such as skids and/or a landing gear, is lifted off a ground or set down on a ground.

The invention relates to a method for simulating flight attitudes of an aircraft capable of vertical takeoff and/or vertical landing according to the preamble of claim 1.

Simulators for flight simulation which allow simulation of the movement of an object to be simulated, for example an aircraft, in six spatial degrees of freedom are known. Such simulators are configured as hexapods or so-called Stewart platform, which support a model of the cockpit of an aircraft to be simulated. The windows are surrounded by display screens or projection screens, on which images of the surroundings matching the respective simulation condition are displayed.

Disadvantageously, such flight simulators are very large, heavy, expensive and inflexible. A certain type of a flight simulator is only capable of simulating a single type of aircraft, whereby the full functionality and, in particular, the full movement of the actual aircraft typically cannot be simulated, because conventional flight simulators only have limited actual mobility. For example, rolls representing maneuvers that can generally be executed with any type of aircraft cannot be simulated with conventional flight simulators. Such conventional flight simulators are already quite limited at the maximum actually attainable banking as well as at the actually attainable angle of climb or angle of attack. The representation of the surroundings suggests to the user much greater values for the respective angles than the actual banking or angle of climb or attack. In addition, the acceleration attainable with conventional flight simulators is very limited. This has been shown to cause nausea in the subjects because the actual banking and/or or acceleration detected by the human sensory organs do not match the visually detected or displayed banking and/or acceleration. Such flight simulators are typically only accessible to a very limited group of people due to their complexity and high cost.

The conventional flight simulators are disadvantageously also unable to simulate particularly critical, but realistic flight attitudes, whereby the simulation could actually replace flight training in an actual aircraft.

It is therefore an object of the invention to provide a method for simulating flight attitudes of an aircraft of the aforedescribed type which is capable of vertical takeoff and/or vertical landing, which obviates the aforementioned disadvantages and is able to realistically simulate critical flight attitudes, so that the number of actual flight hours for learning such flight attitudes can be significantly reduced.

This is attained with the invention by the features of claim 1.

In this way, critical flight attitudes, in particular during start and landing, of an aircraft capable of vertical takeoff and/or vertical landing, for example a helicopter, can be realistically simulated so that the cost for flight hours on a real aircraft, as required until now for learning such flight attitudes, can be significantly reduced. With the method of the invention, a subject is forced to perform a real “start” or “landing”, i.e., actually lift the skids or the landing gear of the aircraft from the ground or to set them down again on the ground. All accelerations and jolts, but also the visuals, correspond to the actual conditions during start and landing of an actual aircraft. In this way, the cost for pilot training can be significantly reduced, while considerably enhancing the quality, because significantly more starts and landings can be trained for fraction of the cost of real flight hours than was possible until now. With the realistic simulation and the possibility to design the simulation significantly more intensely at lower costs than with real flight hours, the level of training of the flight students is improved, which also significantly reduces the risks of accidents when handling a real aircraft. Moreover, there is also less impact on the environment due to noise and contaminants. Methods according to the invention can be performed on systems which can also be arranged in a no-fly zone or in a quiet residential area of a city. Such systems are not tied to conventional airports.

The invention relates to a simulator for flight simulation according to the preamble of claim 2.

It is therefore another object of the invention to provide a simulator for flight simulation of the aforedescribed type, which is able to obviate the aforementioned disadvantages, which has a simple and cost-effective construction, which can be flexibly adapted to different flight simulations, and which has a high mobility.

This is attained with the invention by the features of claim 2.

In this way, a flight simulator can be constructed which has significantly greater mobility than a conventional flight simulator based on a Stewart platform. Such simulator according to the invention is also suitable to expose a subject to significantly greater accelerations than conventional simulators based on a Stewart platform, which more particularly results in a much better match between the sensory motion and the visually displayed motion. This type of simulator according to the invention for flight simulation can realistically simulate extreme flight attitudes, from upside down flight, rolls, steep turns and simple aerobatic figures to situations during air combat. With the actually attainable banking and/or angles of climb or attack, which agree with the simulated angles much better than was possible until now, and/or with the actually attainable accelerations, which agree with the simulated accelerations much better than was possible until now, the subjects experience nausea with a simulator according to the invention for flight simulation only at significantly more extreme movements than, for example, in a simulator based on a Stewart platform.

Due to the great flexibility of a simulator according to the invention for flight simulation, such simulator is not limited to the simulation of a single type of aircraft. Instead, a large number of different movement situations can be simulated, for example motorcycling, steering a ship or a kayak in heavy seas or whitewater, skiing, riding a bicycle downhill, etc.

Due to the low production and operating costs of such simulator for flight simulation, such simulator can also be made accessible to a significantly larger group of people than was possible to date with conventional simulators. In this way, as well as due to the much greater experienced realism, a simulator according to the invention for flight simulation can make significant contributions to the training of drivers, pilots and athletes, because dangerous flight attitudes, such as tailspins, can be realistically simulated.

Due to its simple construction and the low costs, a simulator according to the invention can also be used for entertainment purposes, wherein for example driving and/or flight simulation games for computers and/or game consoles can be adapted to operate with a simulator according to the invention for driving and/or flight simulation. A significantly enhanced game experience can be attained, or the boundaries between a game and a realistic simulation can be shifted significantly. The external forces on the imaginary figure in a game can now be sensed by a human player for the first time. A simulator according to the invention for a vehicle and/or flight simulation can therefore also be installed in amusement arcades and/or on country fairs.

The dependent claims, which like the claims 1 and 2 form part of the description, recite additional advantageous embodiments of the invention.

The invention will now be described with reference to the appended drawings which illustrate only exemplary preferred embodiments in more detail.

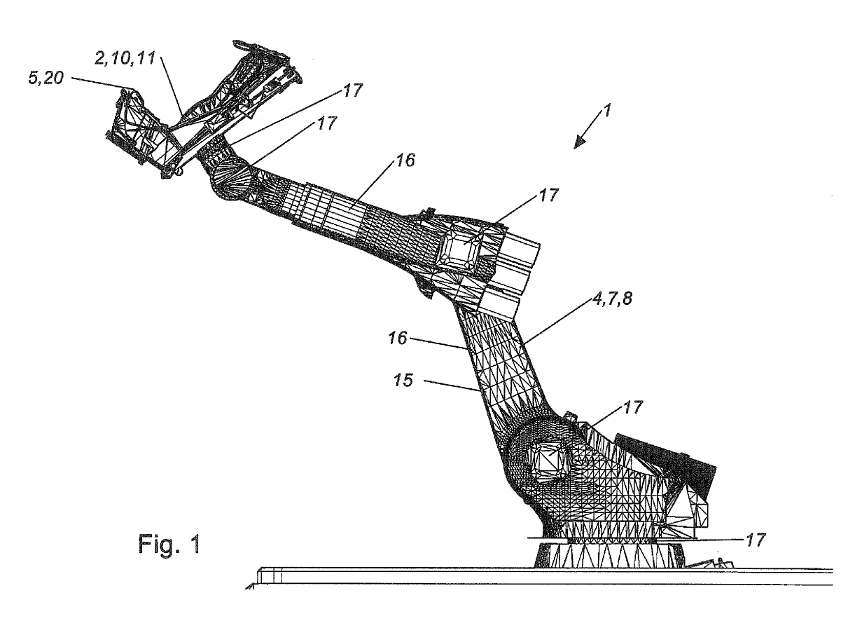

FIG. 1 shows a preferred embodiment of a simulator according to the invention in a vertical section;

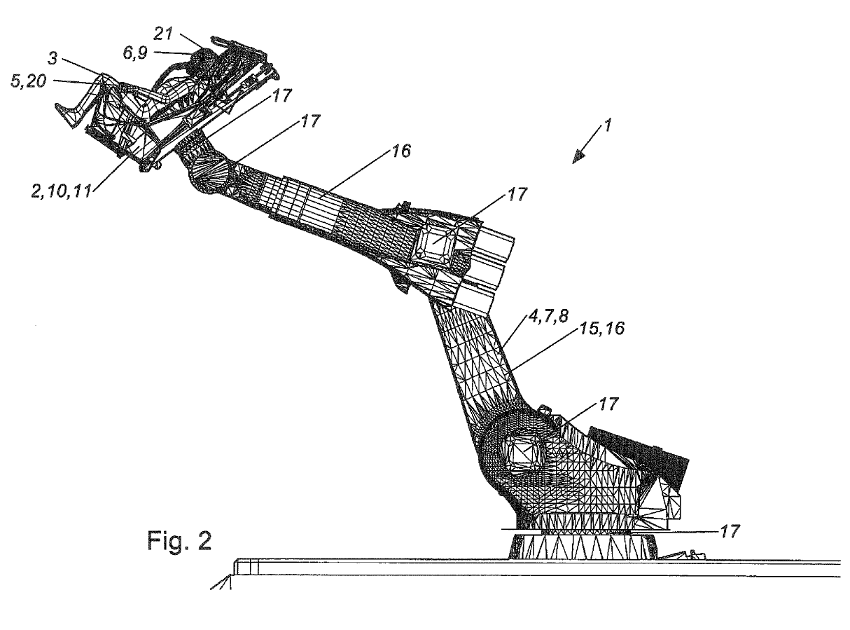

FIG. 2 shows the view of FIG. 1 with a subject;

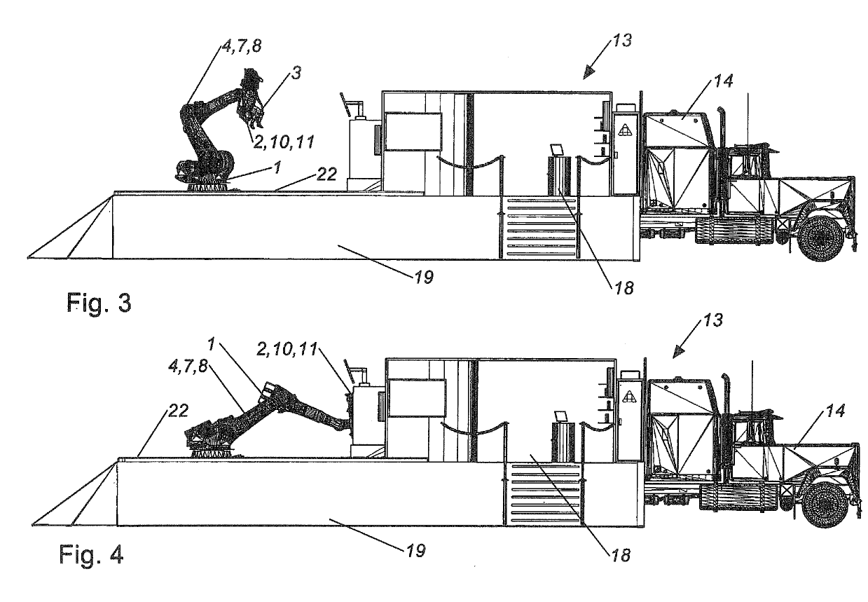

FIG. 3 shows a preferred embodiment of a mobile simulation unit according to the invention with a simulator according to FIG. 2 in operation;

FIG. 4 shows a mobile simulation unit according to FIG. 3 in a rest position; and

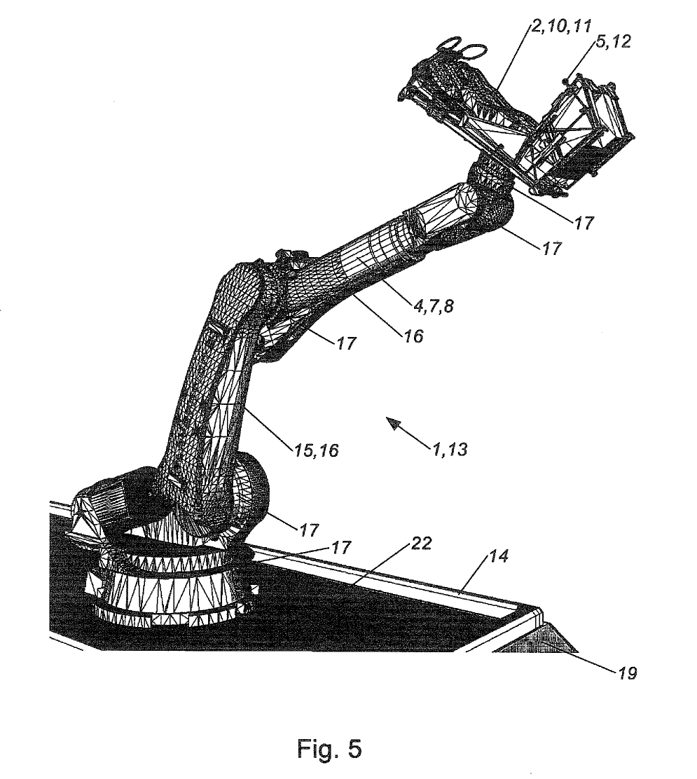

FIG. 5 shows a simulator according to FIG. 1 in an axonometric representation.

FIGS. 1 to 5 show a simulator 1 for flight simulation, including at least one first support 2 for at least one subject 3, a movement device 4, at least one control element 5 and at least one full-video visualization device 6, wherein the first support 2 is connected with the movement device 4 in a substantially rigid fashion, wherein the movement device 4 is configured for moving the first support 2 in at least six spatial degrees of freedom, wherein the control element 5 is configured for at least indirect interaction of the subject 3 with the movement device 4, and wherein the full-video visualization device 6 is configured for visualizing simulated surroundings, wherein the movement device is implemented as an industrial robot with serial kinematics.

Such simulator 1 for flight simulation is particularly well configured for performing the method for simulating flight attitudes of an aircraft capable of vertical take-off and vertical landings according to the invention.

In this way, a simulator 1 for flight simulation can be constructed which can be used flexibly, without substantial structural adaptations, for many different flight simulations. Such a simulator 1 for flight simulation can be manufactured and operated at only a fraction of the cost of a conventional simulator based on a Stewart platform, and enables in many applications a significantly more impressive and/or realistic simulation of a driving and/or flight simulation than conventional simulators for flight simulation.

A flight simulator can thus be constructed which has significantly greater mobility than a conventional flight simulator based on a Stewart platform. Such simulator 1 according to the invention is also suitable to expose a subject to significantly greater accelerations than conventional simulators based on a Stewart platform, which results, in particular, in a significantly greater agreement between the sensed motion and the visually displayed motion. With a simulator 1 of this type according to the invention also extreme flight attitudes, such as upside down flight, rolls, steep turns and simple aerobatic figures to air combat situations can be realistically simulated. With the actually attainable banking and/or angles of climb or attack, which are in significantly better agreement with the simulated angles than has been possible to date, the subject experiences nausea with the simulator 1 for flight simulation according to the invention only at significantly more extreme movement situations than, for example, in a simulator based on a Stewart platform.

When used as a driving simulator, driving conditions and road conditions can be simulated much better, in particular more realistically, than known thus far, so that simple differences between different vehicles can be experienced during simulation.

Due to the great flexibility of the simulator 1 for flight simulation according to the invention, such simulator is not limited to simulations of an aircraft or automobile. Instead, many different driving situations can be simulated, such as motorcycling, steering a ship or a kayak in heavy seas or whitewater, skiing, racing downhill on a bicycle, etc.

Due to the low manufacturing and operating cost of such simulator 1 for flight simulation, the simulator can also be made available to a much larger group of people, which has so far not been possible with conventional simulators 1. In this way, as well as due to the potentially greater realism, a simulator 1 for flight simulation according to the invention could also make significant contributions to the training of drivers, pilots and athletes, because dangerous driving and/or flight attitudes, such as skidding or tailspins, can be realistically simulated.

A simulator 1 for flight simulation according to the invention can, due to the simple construction and the low costs, also used for entertainment purposes, whereby for example flight simulation games for computers and/or game consoles can be adapted to operate with the simulator for flight simulation according to the invention. In this way, the so far only visually displayed movement situations and/or accelerations can now be experienced and lived through by the player with his own body. This significantly enhances the game experience, and the boundaries between game and realistic simulation are shifted significantly. In this way, the external conditions affecting a figure in the game can, for the first time, also be sensed by the player. A simulator for flight simulation according to the invention can then also be installed in amusement arcades and/or on country fairs.

A simulator 1 for flight simulation according to the invention is provided predominantly for simulating essentially all movements, to which humans can be exposed by devices, arrangement and/or animals, and which behavior they can influence in a controlled manner. This may include, for example, land vehicles, such as automobiles, motorcycles, trains, construction equipment, bicycles and/or tanks, aircrafts, such as airplanes, helicopters and/or vertical takeoff planes, space vehicles, for example the space shuttle, watercraft, such as motor boats, sailboats and/or kayaks, sporting equipment, such as skateboards, surfboards and/or skis, but also mounted animals, such as horses, elephants or dromedaries. Hereinafter, only the term vehicle will be used for ease of comprehension. This term may be interpreted as including all of the aforementioned devices, arrangements and/or animals.

The present invention further includes a method for simulating flight attitudes of an aircraft capable of vertical takeoff and landing, with a simulator 1 having a movement device 4 implemented as an industrial robot 7 with serial kinematics, wherein movements of a first support 2 arranged on the movement device 4 for at least one subject 3 are controlled by at least one control element 5, wherein the at least one control element 5 is operated by a subject 3 located in the first support 2 such that a ground contact device connected with the first support 2, for example skids and/or a landing gear, is lifted off the ground and set down again on the ground.

The term “aircraft capable of vertical takeoff and/or vertical landing” includes any type of aircraft capable of starting, i.e., lifting off vertically, and/or landing, i.e., setting down on the ground. This term includes, in particular, all types of so-called VTOL aircraft (VTOL—Vertical Take-Off and Landing), accordingly any type of helicopter, but also aircrafts such as the Harrier, the F-35 or the Yak-38, or tilt-rotor aircraft such as the V-22.

In this way, critical flight attitudes, in particular start and landing, of an aircraft capable of vertical takeoff and/or vertical landing, such as a helicopter, can be realistically simulated, so that the expense for flight hours on an actual aircraft, which has so far been necessary for learning such flight attitudes, is now much lower. With the method of the invention, a subject is required to realistically perform a “start” and a “landing”, respectively, i.e., to actually lift the skids or the landing gear of the aircraft actually off the ground and to set it down again on the ground. All accelerations and jolts, but also the visual appearance of the actual conditions during start and landing correspond to that of an actual aircraft. In this way, the costs for pilot training can be significantly reduced, while simultaneously also significantly improving the quality, because significantly more starts and landings can be trained than was hitherto possible at a fraction of the cost of real flight hours. With the realistic simulation and the possibility to make the simulation significantly more intensive at lower costs than with real flight hours, the training travel of the student pilots increases, thereby significantly reducing the risk of an accident during final handling of an actual aircraft. This also reduces the impact on the environment due to noise and contaminants. Methods of the invention can be performed on systems which can also be arranged in a no-fly zone or a quiet residential area of a city. Such systems are not tied to conventional airports.

A simulator 1 for flight simulation according to the invention includes at least one first support 2 for at least one subject 3, wherein the first support 2 for a subject 3 maybe of any type. Preferably, the first support 2 is configured according to the planned simulation task. In a preferred application of a simulator 1 according to the invention for simulating an aircraft and/or a land vehicle, the at least one first support 2 is implemented as a seat 10, in particular an airplane seat 11, an automobile seat and/or a motorcycle seat. In a particularly preferred embodiment, the seat 10, as illustrated in FIGS. 1 to 3 and 5, may be a replica of an ejection seat of a military aircraft. However, seats 10 from a conventional aircraft and from motor vehicles may also be used.

According to the invention, at least one first support 2 for a subject 3 is provided. A predetermined number of first supports 2 for a predetermined number of subject 3 may be provided. The predetermined number of supports 2 may be part of a cockpit or a cockpit model, for example of an aircraft or a land vehicle, whereby the simulation can be particularly realistic, because with such an arrangement, the operating and control elements 5 may be arranged and operated according to the vehicle to be simulated.

In a particularly preferred embodiment, the simulators 1 according to the invention for use with the aforedescribed method may include a ground contact device, which is preferably connected rigidly or movably with the first support in such a way that during start or landing, i.e., during liftoff from or setting down on a support or ground, the vibrations transmitted to the first support correspond predominantly to the vibrations that occur in a comparable actual aircraft. Depending on the aircraft to be simulated, the ground contact device is configured as skids, landing gear or a combination of the two.

The first support 2 is essentially rigidly connected with a movement device 4, wherein the movement device 4 is configured to move the first support 2 in at least six spatial degrees of freedom. With the movement device 4, the first support 2 and a subject 3 placed in the support 2 can be moved freely in space within certain limits, as defined by the adjustment possibilities of the movement device 4. The subject 3 can then be moved and subjected to accelerations in a way that has not been possible to date with conventional simulators. According to the invention, the movement device 4 is implemented as an industrial robot 7 with serial kinematics. Such industrial robots 7 with serial kinematics are manufactured in multiple configurations and are used in automated manufacturing. Preferably, the industrial robot 7 with serial kinematics is configured as an articulated arm robot 8, in particular an articulated arm robot with the least six adjustable axes. Such articulated arm robot 8 has at least one robotic arm 15 which has a predetermined number of partial arms 16 which are connected with each other by joints 17. FIGS. 1 to 5 show a preferred embodiment of an industrial robot 7 with serial kinematics as a so-called 6-axes articulated arm robot 8. The term axis refers preferably to each axis representing a symmetry axis, about which or along which an adjustment can be performed, i.e., a rotational adjustment about an axis and/or a translational adjustment along an axis. Preferably, the joints 17 of the articulated arm robot 8 for a simulator according to the invention are adjusted electromechanically. Alternatively, the adjustment can also be performed hydraulically and/or pneumatically.

The term degree of freedom is to be understood as degree of freedom in a purely physical sense, such as three degrees of freedom for translation and three degrees of freedom for rotation. The term degree of freedom can also be understood in the sense that each degree of freedom designates an independent possibility of movement of the movement device 4, here of the industrial robot 7 with serial kinematics. An industrial robot 7 with serial kinematics, which has six mutually independent movement possibilities, for example the robot illustrated in FIGS. 1 to 5, therefore does not necessarily require six physical degrees of freedom. A possibility for translation perpendicular to the robotic arm 15, which is lacking in the embodiment according to FIGS. 1 to 5, is unimportant because such movement is not possible with most vehicles to be simulated.

A simulator 1 according to the invention for flight simulation has at least one control element 5 for at least indirect interaction between the subject 3 and the movement device 4. The control element 5 is preferably adapted to the vehicle to be simulated, and configured corresponding to the preferred applications as steering wheel and/or control stick 12, wherein the additional control elements, such as driving pedals, throttles 20, brake pedals, trim wheels, rudder pedals, handlebars, reins, stirrups and the like may be provided. The embodiment illustrated in FIGS. 1 to 5 includes two control elements in form of a throttle 20 and a control stick 12. According to the arrangement of the major control elements typical in modern fighter planes, commensurate with the premise that the pilot should not take his hands off the throttle 20 and the control stick 12 (HOTAS: hands on throttle and stick), additional control elements 5 may be arranged on the throttle 20 and the control stick 12, which are not shown in FIGS. 1 to 5. The subject can influence the behavior of the movement device 4 by way of the at least one control element 5. Preferably, this does not represent direct control of the movement device 4. Instead, the subject 3 may transmit via the at least one control element 5 control commands to at least one computing and control unit, which controls the movement device 4 by taking into consideration the properties of the vehicle to be simulated and the respective status of a currently running simulation. The reaction of the vehicle typically depends on its respective travel conditions—corresponding to the status of a simulation, for example affected by wind and gusts, and is therefore taken account by the computing and control unit when controlling the movement device 4.

The at least one computing and control unit furthermore controls a full-video visualization device 6, which is configured for visualizing simulated surroundings, wherein the respective visualized surroundings are continuously adapted by the computing and control unit to the respective simulation. Preferably, the full-video visualization device 6 may have at least one display screen which is, in particularly rigidly, connected with the at least one support 2, and/or the full-video visualization device 6 includes at least one projector which projects a picture onto at least one projection surface arranged around the simulator. Use of a display screen represents a simple and effective solution, in particular in conjunction with the use of a cockpit model, because the cockpit windows can hereby be formed by the display screens. By using projectors and projection surfaces, the illusion of a wide free space can be created around the subject 3.

In a particularly preferred embodiment according to FIG. 2, the full-video visualization device 6 includes at least one pair of video glasses 9, which includes in particular a position sensor. In the embodiment of FIG. 2, the video glasses are integrated in a pilot helmet 21 worn by the subject 3. The position sensor, which may be formed from acceleration sensors or a laser gyro, transmits data about the respective current viewing direction to the computing and control unit, which adapts the video signal for controlling the full-video visualization device 6 accordingly. Video glasses 9 can advantageously fill the entire field of view of the subject 3, thereby preventing distraction of the subject 3 by external events.

In addition, sound, tone and/or noise background adapted to the simulation can be outputted by the computing and control unit.

In a particularly preferred embodiment, at least one computing and control unit may include a game console and/or a personal computer. A game console and/or a personal computer may form part of the computing and control unit and/or a game console and/or a personal computer may control the computing and control unit, whereby a game console and/or a personal computer and the computing and control unit then form an assembly. In this way, commercial or otherwise adapted simulation software can be employed with game consoles and/or personal computers in conjunction with a simulator 1 according to the invention. This approach significantly expands the applicability of a simulator 1 according to the invention. Because of the flexibility and low manufacturing and operating costs of a simulator 1 according to the invention, simulators can be offered to the general public at low cost with a quality that has so far not even been available to professional users.

In such embodiment of the described invention, wherein the computing and control unit includes a game console and/or a personal computer, a preferred method for driving and/or flight simulation is additionally provided, wherein a computer game is played on a game console and/or a personal computer, in which a game figure of an Ego-Shooter, adventure, sports and/or jump-and-run game, and/or a vehicle, such as a vehicle of a Formula-1 game, and/or an aircraft of an air combat game, are moved. The player transmits control commands for controlling the movement of the figure and/or the vehicle to the game console and/or the personal computer. According to the preferred method, at least a first control command is transmitted to the game console and/or the personal computer—or the computing and control unit which is formed as an assembly together with the game console and/or the personal computer—, wherein with the first control command the movement and/or acceleration of a figure and/or a vehicle in the computer game is controlled, wherein the game console and/or the personal computer produces at least one output signal, and the movement and/or acceleration of the first support 2 is controlled with the output signal, wherein the actual movement and/or acceleration of the first support 2 is at least equivalent to the movement and/or acceleration of the figure and/or of the vehicle in the computer game. The player hence plays a computer game, and the movements and/or accelerations of the figure and/or of the vehicle—as influenced by the progression of the play—are equivalently transferred to the movements and/or accelerations of the first support. The term equivalent indicates herein preferably the bijective image of the movement and/or acceleration space of the figure and/or of the vehicle in the computer game on the movement and/or acceleration space of the industrial robot 7 with serial kinematics. With the method of the invention, if the player is situated in the first support 2, the movements and/or accelerations which the figure and/or the vehicle experience in the computer game can provide a haptic sensation, thereby providing computer games a thus far unknown realism and dramatic experience. This can produce physical exercise for the player, thereby counteracting the physical shortcomings which are widespread with computer games and caused by lack of physical movement. With the direct experience of the game situations, the cardiovascular system and the muscle development are also stimulated.

In this context, a mobile simulation unit 13 can be provided, wherein—as illustrated in FIGS. 3 to 5—a simulator 1 according to the invention is arranged on a vehicle 14 or a trailer. All the equipment necessary for the safe operation of the simulator 1 is hereby arranged on the loading platform 22 of a truck, wherein also an access and/or cashier area 18 is provided. Swing-down sidewalls 19 of the platform 22 are used for stabilizing the vehicle 14 under load, thereby preventing oscillations of the entire arrangement during operation of the simulator 1. Moreover, a mobile simulation unit 13 of this type may include conventional game consoles, whereby a subject 3 can play a familiar game on the simulator 1 after paying a user fee.

What is claimed is:

1-12. (canceled)

13. A simulator for flight simulation, comprising:
at least one first support for at least one subject,
a movement device implemented as an industrial robot with serial kinematics and essentially rigidly connected with the least one first support and configured to move the at least one first support in at least six spatial degrees of freedom,
at least one control element configured for at least indirect interaction by the subject with a movement device, and
at least one full-video visualization device configured for visualizing a simulating surroundings.

14. The simulator of claim 13, wherein the movement device is implemented as an articulated-arm robot.

15. The simulator of claim 13, wherein the full-video visualization device includes at least one display screen which is substantially rigidly connected with the at least one support.

16. The simulator of claim 13, wherein the full-video visualization device includes at least one pair of video eyeglasses.

17. The simulator of claim 13, wherein the full-video visualization device includes at least one projector.

18. The simulator of claim 13, wherein the at least one first support is formed as a seat.

19. The simulator of claim 18, wherein the at least one seat is part of a cockpit or a cockpit model which is arranged on the movement device.

20. The simulator of claim 13, wherein the at least one control element is selected from the group consisting of steering wheel, control stick and foot pedal.

21. The simulator of claim 13, further comprising at least one computing and control unit, wherein the movement device, the at least one control element, and the full-video visualization device are connected to the computing and control unit.

22. The simulator of claim 21, wherein the at least one computing and control unit comprises a game console or a personal computer, or both.

23. A mobile simulation unit comprising:
a simulator for flight simulation with
at least one first support for at least one subject,
a movement device implemented as an industrial robot with serial kinematics and essentially rigidly connected with the least one first support and configured to move the at least one first support in at least six spatial degrees of freedom,
at least one control element configured for at least indirect interaction by the subject with a movement device, and
at least one full-video visualization device configured for visualizing a simulating surroundings, and
a vehicle or a trailer on or in which the simulator is mounted.

24. A method for simulating flight attitudes of an aircraft capable of at least one of vertical takeoff and landing, with a simulator having a movement device implemented as an industrial robot with serial kinematics, comprising the steps of:
controlling with at least one control element movements of a first support for at least one first subject positioned on the movement device, and
operating the at least one control element by a subject positioned in the first support so that a ground contact device connected with the first support are raised from a ground or set down again on the ground.

25. The method of claim 24, wherein the ground contact device comprises at least one of skids and a landing gear.
